(19) United States
(12) Patent Application Publication
(10) Pub. No.: US 2008/0095331 A1
(43) Pub. Date: Apr. 24, 2008

(54) SYSTEMS AND METHODS FOR INTERACTIVELY ACCESSING NETWORKED SERVICES USING VOICE COMMUNICATIONS

(75) Inventor: Eugeniusz Wlasiuk, Suchy Dwor (PL)

Correspondence Address: BAKER & MCKENZIE LLP;PATENT DEPARTMENT, 2001 ROSS AVENUE, SUITE 2300, DALLAS, TX, 75201, US

(73) Assignee: PROKOM INVESTMENTS S.A., Gdynia (PL)

(21) Appl. No.: 11/550,754

(22) Filed: Oct. 18, 2006

(51) Int. Cl. H04M 11/00

(52) U.S. Cl. 379/88.14

(57) ABSTRACT

A system for using voice communications to access networked services is disclosed. The system includes a voice recognition module in communications with a network, a text understanding module, a first domain system a pool of domain system agents, and an order manager. The voice recognition module is configured to receive voice commands from a telephony device that is connected to the network and transform those commands into text files. The text understanding module is configured to translate a text file into a set of structured logical objectives. The first domain system is configured to host the networked services. Each one of the domain system agents is associated with one of the networked services hosted by the first domain system.

The order manager is in communications with the voice recognition module, the text understanding module, and the pool of domain system agents. Further, the order manager is configured to: receive the set of structured logical objectives from the text understanding module, determine whether the set of structured logical objectives contains the necessary information to identify which networked service is being requested by the telephony device, and activate the domain system agent associated with the requested networked service when the set of structured logical objectives contains the necessary identification information. After activation, the domain system agent is configured to facilitate communications between the telephony device and the first domain system.

### BACKGROUND

1. Field of the Invention

The embodiments disclosed in this application generally relate to an interactive voice response system to enable voice command access of networked services (e.g., banking, insurance, healthcare, shops, etc.) via telephony.

2. Background of the Invention

Corporations today routinely provide customer service via the Internet and the telephone for reasons of cost or expediency. Currently, users may obtain such Internet services from an access device that offers visual presentation capabilities—for example, a personal computer (PC) with an Internet web browser that requests and receives HyperText Markup Language (HTML) documents produced by a Web server. For e-commerce applications, the Web server has or provides access to service logic and transaction server interfaces that process the user's input. The service logic is programmed using any number of popular Web programming tools.

Users obtain telephone services with an access device that has audio interaction capabilities—for example, a telephone or a voice over Internet protocol (VOIP) device calling an interactive voice response (IVR) platform that has audio input, output, and telephony functions and its own service logic and transaction server interface. IVR systems are automated to allow a telephone user to access linked services on the system through verbal commands. The service logic is typically programmed in a general-purpose software language using the platform's application-programming interface (API), or a platform specific scripting language.

Traditional interaction styles of IVR systems include menus, directed dialogs, and mixed-initiative dialogs made possible by improvements in speech recognition technology. Menu style interactions typically use pre-recorded voice prompts asking the user to press a number on a telephone keypad or speak simple answers (e.g., “yes”, “no”, or simple numbers) to select an item from a set of choices. In directed dialogs, the system leads the user through a collection of data by asking discrete questions that require discrete answers. For example, to find out where a person resides, a discrete dialog system would first ask for the person to name the state he lives in followed next by asking for the city. Mixed-initiative dialog systems let the user enter multiple pieces of data in a single utterance and provide partial information.

Despite these advances, conventional IVRs still tend to be slow, impersonal, and offer a cumbersome platform for assisting interactions between the system and user. Maneuvering through a maze of menu options and choices on the phone tends to be very time consuming and the voice command recognition/understanding features of directed and mixed-initiative dialog systems are not designed to effectively handle voice command that are not responsive to scripted questions. In short, none of the existing IVRs allow for true interactive navigation of services by users.

### SUMMARY

Methods and systems for interactively accessing networked services using voice communications are disclosed.

In one aspect, a system for using voice communications to access networked services is disclosed. The system includes a voice recognition module in communications with a network, a text understanding module, a first domain system, a pool of domain system agents, and an order manager. The voice recognition module is configured to receive voice commands from a telephony device that is connected to the network and transform those commands into text files. The text understanding module is configured to translate a text file into a set of structured logical objectives. The first domain system is configured to host the networked services. Each one of the domain system agents is associated with one of the networked services hosted by the first domain system.

The order manager is in communications with the voice recognition module, the text understanding module, and the pool of domain system agents. Further, the order manager is configured to: receive the set of structured logical objectives from the text understanding module, determine whether the set of structured logical objectives contains the necessary information to identify which networked service is being requested by the telephony device, and activate the domain system agent associated with the requested networked service when the set of structured logical objectives contains the necessary identification information. After activation, the domain system agent is configured to facilitate communications between the telephony device and the first domain system.

In a different aspect, a method for accessing networked services using voice communications is disclosed. A voice command is received. The voice command is converted into a text file. A text understanding module and a language processing resource translates the text file into a set of structured logical objectives. The set of structured logical objectives is analyzed to determine whether it contains the necessary information to identify which networked service is being requested by the voice command. The domain system agent associated with the requested network service is activated when the set of structured logical objectives contains the necessary identification information.

In another aspect, a method for interactively acquiring data for accessing networked services is disclosed. A request to access networked services is received. A session packet is created that includes applicable data for that request. The applicable data in the session packet is evaluated to determine whether the packet contains required data. When the request lacks the required data, a question is generated to query the required data. The question is sent to a voice generator object.

These and other features, aspects, and embodiments of the invention are described below in the section entitled “Detailed Description.”

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 is a diagram illustrating the functional elements of an Interactive Voice Response (IVR) system that permits a user to interactively access networked services using voice communications, in accordance with one embodiment.

FIG. 2 is a detailed illustration of the internal components of an order manager that can be included in the system of FIG. 1 and how those components interact with the rest of the modules in the voice interface system, in accordance with one embodiment.

FIG. 3 is an illustration of a process flowchart detailing the processing steps executed by the voice interface system when a user accesses a networked resource via voice communications, in accordance with one embodiment.

### DETAILED DESCRIPTION

An invention is described for methods and systems for interactively accessing services using voice communications. It will be understood, however, that the present invention may be practiced without some or all of these specific details. In other instances, well known process operations have not been described in detail in order not to unnecessarily obscure the present invention.

As used herein, telephony is the general use of equipment (e.g., land line phones, mobile phones, Internet communications devices, etc.) to provide voice communication over distances. Telephony encompasses traditional analog phone systems that transmit voice communications via analog type signals (i.e., continuous in time and amplitude) and more recent digital phone systems that transmit voice communications via digital type signals (i.e., discrete binary). Voice over Internet protocol (VOIP) is a modern form of digital-based telephony that uses transmission control protocol/Internet protocol (TCP/IP) and other network transmission formats for transmitting digitized voice data through the Internet.

The Internet or World Wide Web (WWW) is a wide area network (WAN) made up of many servers linked together allowing data to be transmitted from one server to another using network data transmission protocols such as TCP/IP, Reliable User Datagram Protocol (RUDP), or their equivalents. Typically, the Internet links together a multitude of servers that are located in a wide geographical area. In contrast, local area networks (LAN) are smaller networks of servers such as those covering a small local area, like a home, office, or small group of buildings such as a home, office, or college.

In view of the foregoing, it should be appreciated that an IVR system can benefit from the systems and methods, described herein, for interactively using voice communications to determine which services are requested by customers and delivering those services to them without using menu driven or pre-scripted dialogue.

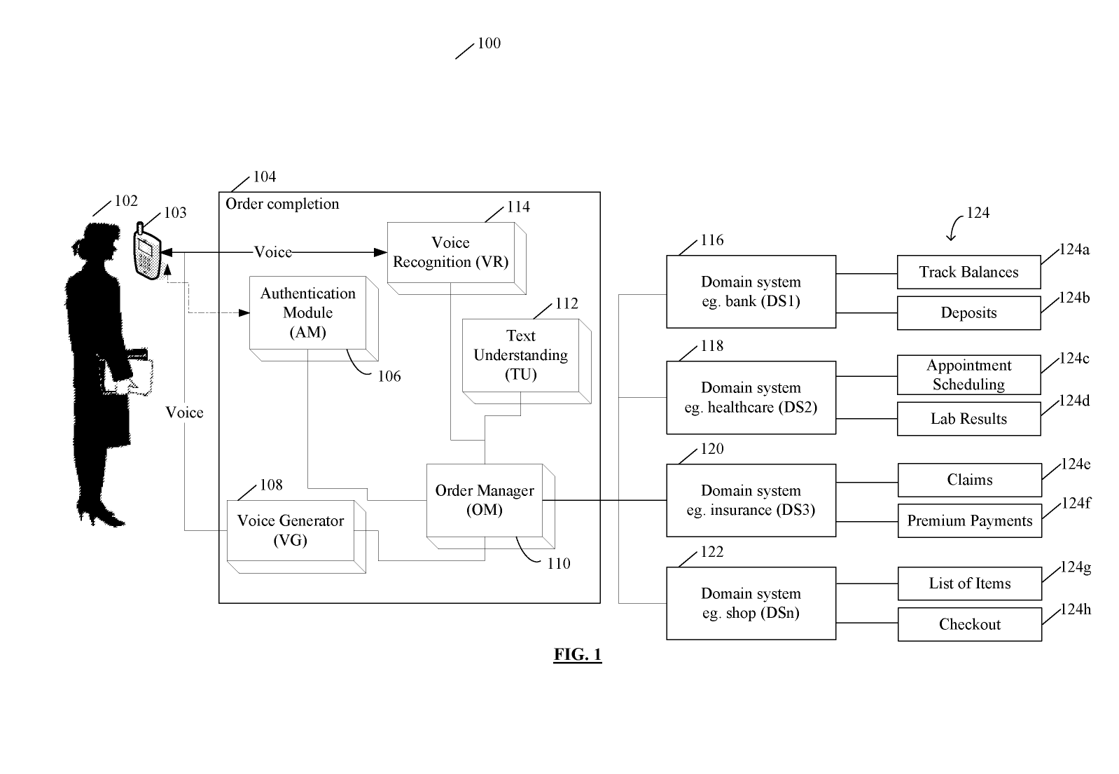

FIG. 1 is a diagram illustrating the functional elements of an Interactive Voice Response (IVR) system that permits a user to interactively access networked services using voice communication, in accordance with one embodiment. As depicted herein, the system 100 includes a user 102 operating a telephony device 103 that is configured to be in communications with a voice interface system 104 linked to a plurality of different domain systems (e.g., Bank 116, Healthcare 118, Insurance 120, and Shopping 122). The domain systems provide access to a plurality of services 124.

In order to be accessed via the voice interface system 104, each service 124 must first be registered to one or more of the domain systems linked to the voice interface system 104. Each domain system is configured to register a plurality of services 124 and provide them to the user 102 through the voice interface system 104. For example, during the registration process, the service should provide: the geographic regions in which the service is available, a unique identifier (i.e., name) of the service in a language supported by the voice interface system 104, a detailed description of the service in a language that is supported by the voice interface system 104, a list of required information from the user 102 in order for the service to be provided to the user 102, and an identification of the domain system resources utilized when providing the service. However, it should be appreciated, that the examples of information to provide during the services registration process is to be used for illustrative purposes only and should not be seen as limiting the types of information that may be required to register a service to a domain system. The services registration process may be customized by a system administrator to require less or more types of information to be provided about the services; limited only by the ability of the voice interface system 104 to process the information and the needs of the particular application.

In one embodiment, each service registered is related to an overall domain system schema. For example, the services 124a and 124b of tracking account balances and making electronic deposits, respectively, are registered to a bank domain system 116, the services 124c and 124d of appointment scheduling and providing laboratory results, respectively, are registered to a healthcare domain system 118, the services 124e and 124f of submissions of insurance claims and payment of insurance premiums, respectively, are registered to an insurance domain system 120, and the services 124g and 124h of listing items on sale and payment for the items, respectively, are registered to a shopping domain system 122. It should be understood that the examples of domain systems provided in FIG. 1 are to be used for illustrative purposes only, essentially any category (e.g., credit cards, restaurant orders, etc.) of domain system can be linked to the voice interface system 104 as long as the domain system provides services that can be delivered to a user 102 via a telephony device 103.

In one embodiment, the telephony device 103 is communicatively linked with the voice interface system 104 via a land line (e.g., analog physical wire connection, etc.) that is configured to transmit voice data using analog signals. In another embodiment, the telephony device 103 is communicatively linked with the voice interface system 104 via a land line (e.g., digital fiber optic connection, etc.) that is configured to transmit voice data using discrete digital binary signals.

In yet another embodiment, the telephony device 103 (e.g., mobile phone, satellite phone, etc.) is communicatively linked with the voice interface system 104 via a wireless communications link that is configured to transmit voice data to the voice interface system 104 using either radio frequency (RF) or microwave signals. The transmission format can be either analog or digital and the wireless communications link can be either a direct link with the voice interface system 104 or through a base unit that is connected to the voice interface system 104 through a land line or another wireless connection. In still another embodiment, the telephony device 103 (i.e., Internet communications device) is communicatively linked (through either a landline or wireless connection) with the voice interface system 104 by way of a network connection that is configured to transmit voice data using voice over Internet protocol (VOIP) or equivalent protocol. The network connection may be distributed as a localized network (i.e., local area network) or a wide area network (i.e., Internet).

In one embodiment, system 100 can be configured to operate via a user 102 operating a mobile phone (i.e., telephony device 103) to place a call into the voice interface system 104 to access a service that is linked to the voice interface system 104 via a domain system. The mobile phone 103 communicates by way of a RF link with a mobile phone provider (i.e., cellular network provider), which is itself linked to a public switched telephone network (PSTN) (i.e., land line) that is in communications with the voice interface system 104. The voice interface system 104 can in turn be communicatively linked with multiple domain systems via the Internet or a LAN. In another scenario, a user 102 operates a VOIP enabled computer (i.e., telephony device 103) to place a VOIP call to a voice interface system 104 that is linked to the Internet. The VOIP enable computer communicates via a broadband Internet connection that is communicatively linked to the voice interface system 104 through a network connection (e.g., Internet, LAN, etc.). Again, multiple domain systems 124 can be connected to the voice interface system 104 via the Internet or a LAN. Each domain system 124 is configured to manage and deliver a multitude of services to a user 102 when requested.

It should be appreciated that the scenarios provided above have been included for illustrative purposes only and are not intended to limit the communications configurations available to the system 100 in any way. There are a multitude of conceivable approaches in which to set up the communications between the user 102 and the voice interface system 104; limited only by the ability of the resulting systems 100 to transmit voice data to the voice interface system 104 with sufficient clarity and specificity to allow the voice interface system 104 to process and understand the voice data.

Continuing with FIG. 1, the voice interface system 104 includes an authentication module 106, a voice recognition module 114, a text understanding module 112, a voice generator module 108, and an order manager module 110. The voice recognition module 114 can be configured to receive voice data from a user 102 via a telephony device 103 that is communicatively linked to the voice interface system 104 using any of the telephony communication configurations described above. In certain embodiments, the voice data includes information about the user 102 (e.g., identification information, authentication information, etc.) as well as information about the linked services 124 that the user 102 is requesting to access. The voice recognition module 114 can be configured to translate the voice data received from the user 102 into text data and transfer that data to the order manager module 110 via a software (i.e., internal logic) or hardware (i.e., device bus) link. It will be understood that voice interface system 104 can comprise the components, both hardware and software, required to carry out the functions described herein. It will be further understood that the voice interface system 104 can comprise other components and functionality, and that certain functions can be carried out by the same or different components. Accordingly, FIG. 1 should not be seen as limiting the systems and methods described herein to a certain architecture or configuration. Rather, FIG. 1 is presented by way of example only.

In one embodiment, the voice recognition module 114 is configured to recognize the, e.g., 30 most common languages of the world. Some examples of languages that the voice recognition module can recognize include: English, Chinese, Hindi, Spanish, Bengali, Portuguese, Russian, German, Japanese, and French. In another embodiment, the voice recognition module 114 is configured to recognize only the languages specified by the services 124 that are registered to the voice interface system 104. It should be understood, however, that the voice recognition module 114 can be configured by the system 100 administrator to recognize any language as long as the linguistic characteristics of the language avails the language to be converted via computer processing. Voice recognition module 114 is further configured to convert the voice of user 102, provided via device 103, into text data.

The order manager module 110 is communicatively connected with the text understanding module 112 and is configured to utilize the logical algorithms in the text understanding module 112 to convert the text data into a set of logical objective statements that can be understood by the order manager 110 to determine which service 124 is desired by the user 102. In one embodiment, the text understanding module 112 uses a logical algorithm based on natural language processing (NLP) to convert the text data into the set of logical objective statements. Natural language processing (NLP) denotes an approach for converting human language into more formal representations that are easier for computer programs to manipulate. Typically, this involves parsing human language text and applying complex logical algorithms to impart a level of abstraction to the text to enable processing by a computer.

In another embodiment, the text understanding module 112 uses a logical algorithm based on ontological semantics processing (OSP) to convert the text data into the set of logical objective statements. Ontological semantics is an approach to NLP that uses a constructed world model, or ontology, as the central resource for extracting and representing the meaning of natural language texts, reasoning about knowledge derived from those texts as well as generating natural language texts based on representations of their meaning. The architecture of an archetypal implementation of ontological semantics comprises: 1. a set of static knowledge sources, namely, an ontology, a fact database, a lexicon connecting an ontology with a natural language and an onomasticon, a lexicon of names (one lexicon and one onomasticon for each language), 2. knowledge representation languages for specifying meaning, structures, ontologies and lexicons, and 3. a set of processing modules, at the least, a semantic analyzer and a semantic text generator. Ontological semantics directly supports such applications as machine translation of natural languages, information extraction, text summarization, question answering, advice giving, collaborative work of networks of human and software agents, etc. It should be appreciated, however, that the text understanding module 114 can essentially use any logical algorithm to convert the text data as long as the resulting set of logical objective statements can be processed by the order manager to determine which network service is being requested in the voice data presented by the user 102.

Still with FIG. 1, once the order manager 110 receives the set of logical objective statements from the text understanding module 112, the order manager 110 sets off to determine whether the statements are sufficient to determine the identity of the service 124 requested by the user 102, and if so, whether the required authentication information was included in the user 102 request. When the information is not sufficient for the order manager 110 to determine the identity of the service 124 requested, the order manager 110 is configured to generate an appropriate text file to query the user 102 for the necessary information required to make that determination. The order manager 110 then forwards the text file to a voice generator module 108 configured to convert the text file into an audio clip, which the voice generator module 108 plays and communicates to the telephony device 103 for the user 102 to listen to.

In one embodiment, this process is repeated by the order manager 110 as often as necessary until the order manager 110 has received sufficient information to determine the identity of the service requested in the voice data presented by the user 102. In another embodiment, this process continues for a pre-determined number of times as specified by the system administrator. It should be appreciated, that the various embodiments discussed above are configured to effectuate highly interactive dialogue between the user 102 and the voice interface system 104. The intention is to mimic, as closely as possible, the communications environment between a user 102 and a live customer service agent trying to determine which services 124 are requested by the user 102.

As with the voice recognition module 114 described above, in one embodiment, the voice generator module 108 is configured to only enable conversion of the 30 most common world languages. In another embodiment, the voice generator module 108 is configured to recognize only the languages specified by the services that are registered to the voice interface system 104. It should be appreciated, however, that the voice generator module 108 can be configured by the system 100 administrator to recognize any language as long as the linguistic characteristics of the language avails the language to be converted via computer processing.

Further depicted in FIG. 1, once the identity of the requested service 124 has been determined, the order manager 110 then ascertains whether the service 124 requested by the voice data requires the user 102 to be authenticated. When user authentication is required, the order manager 110 works in conjunction with the authentication module 106 to obtain the required user 102 authentication information.

Authentication of a user 102 attempting to access a service protected by the order manager 110 can be achieved using a variety of methods. In one embodiment, the authentication of a user 102 involves matching information about some distinguishing characteristic about the user 102 (e.g., biometric information, device configuration, etc.). Examples of biometric-based characteristics can include but are not limited to a user's 102 fingerprints, eye retina/iris, facial pattern, voice signature, etc. In another embodiment, authentication of a user 102 involves confirming something that only the user 102 possesses (e.g., SMARTCARD™, authentication token, etc.). For example, the telephony device 103 operated by the user 102 can store an internal authentication token that identifies the device 103 and thus the user 102 to the authentication module 106 whenever the telephony device 103 connects to the system 100. In yet another embodiment, the authentication of a user 102 involves verifying something that only the user 102 knows (e.g., a password, a pass phrase, personal identification number, keystroke sequence, etc.). For example, a user 102 can enter a numerical keystroke sequence on the telephony device 103 the user 102 is operating, which is then communicated to the voice interface system 104 where the authentication module 106 authenticates the keystroke sequence. In still yet another embodiment, some combination of the three authentication methods described above is utilized to authenticate a user 102. It should be understood, however, that a user 102 can be authenticated using essentially any method, not just those described above, as long as the order manager 110 can establish a user's 102 identity using the method chosen.

As with the process described above for generating queries to obtain information to identify the requested service 124; the order manager 110 is configured to generate a text file to query the user 102 for additional authentication information when the order manager 110 determines that the authentication information submitted by the user 102 is insufficient for the authentication module 106 to successfully authenticate the user 102. The text file is forwarded by the order manager 110 to a voice generator module 108 configured to convert the text file into an audio clip, which the voice generator module 108 plays and communicates to the telephony device 103 for the user 102 to listen to. In one embodiment, this process is repeated until the order manager 110 receives the required authentication from the user 102. In another embodiment, this process is repeated in accordance with a pre-determined limit factor (e.g., time, attempts, etc.) set by the administrator of the system 100. It should be appreciated that the various embodiments discussed above are configured to effectuate highly interactive authentication dialogue between the user 102 and the voice interface system 104. The intention is to mimic, as closely as possible, the communications environment between a user 102 and a live customer service agent trying to authenticate the user 102.

Once the order manager 110 has successfully identified the service requested by the user and authenticates the user to use that service, the order manager 110 is configured to provide the service to the user 102 in conjunction with the domain system hosting the service. The order manager 110 in essence serves as the “middleman” between the user 102 and the domain system to facilitate the delivery of the service to the user 102.

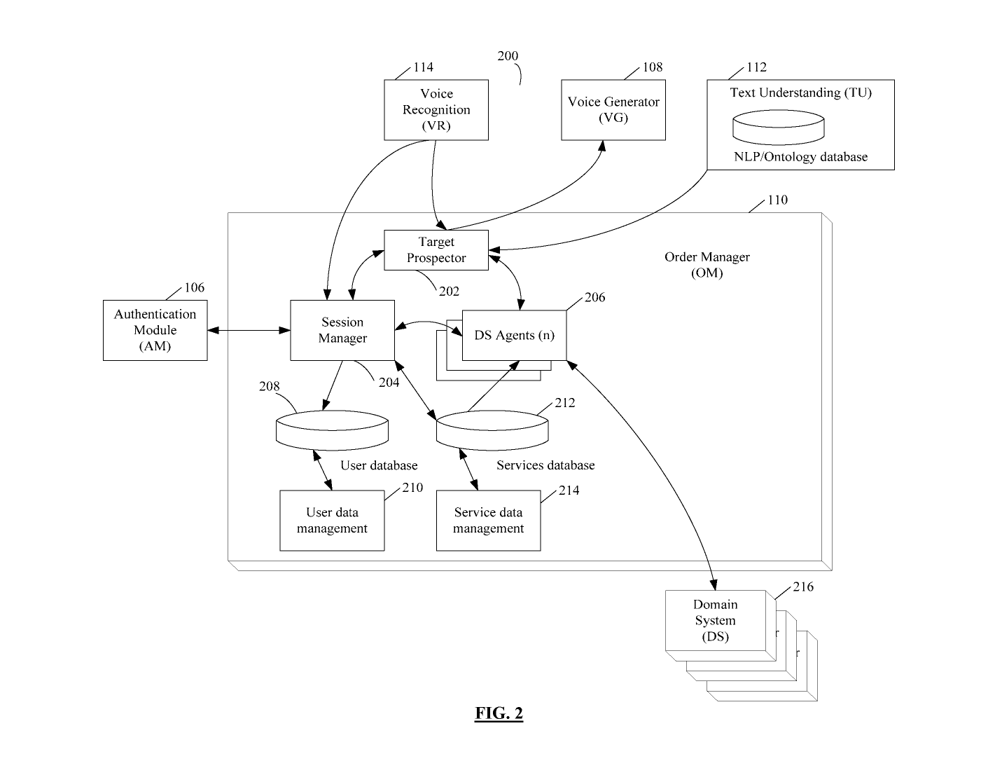

FIG. 2 is a detailed illustration of the internal components of the order manager 110 and how those components interact with the rest of the modules in the voice interface system 104, in accordance with one embodiment. As shown in this embodiment, the order manager 110 includes a target prospector component 202, a session manager component 204, a pool of domain system agents 206, a user database 208, a user data management component 210, a services database 212 and a service data management component 214. Before a user can interact with the voice interface system 104 to access a registered service, the user should first be registered to the user database 208. During user registration, the user may choose to submit authentication data for one particular institution or all the institutions registered to the voice interface system 104.

Typically, the registration process involves the user submitting authentication data (e.g., user biometric data, passwords, etc.), required by the institutions providing the services the user is registered to access, to the voice interface system 104. The authentication data is stored on a user database 208 that is configured to be accessed by the session manager 204 during a user authentication sequence. The user data stored in the user database 208 can also be accessed through a user data management interface 210 that is configured to allow a user or system administrator to modify the user data. For example, if a user wants to create personalized phrases (i.e., “my bank account”) to identify a service (i.e. ABC bank account), the user can access the user data management interface 210 to modify his/her user data to reflect that customization.

Continuing with FIG. 2, when a user communicates via voice commands with the voice interface system 104 to access a registered resource, the commands are routed to a voice recognition module 114 that is configured to convert the commands into text files. After conversion, the text files are sent to the target prospector 202. The target prospector 202 is configured to route the text files to a text understanding module 112 that is configured to apply a logical algorithm to translate the text file into an ordered set of logical objectives that can be understood by the session manager 204. As discussed above in detail, in one embodiment, the text understanding module 112 uses a logical algorithm based on natural language processing (NLP) to convert the text data into the ordered set of logical objectives. In another embodiment, the text understanding module 112 uses a logical algorithm based on ontological semantics processing (OSP) to convert the text data into the set of logical objective statements. Detailed descriptions of the NLP and OSP logical algorithms are provided above. It should be appreciated that the text understanding module 112 can essentially use any logical algorithm to convert the text data as long as the resulting set of logical objective statements can be processed by the session manager 204 to determine which network service is being requested in the voice data presented by the user.

The set of logical objective statements is then sent back from the text understanding module 112 to the target prospector 202, which is configured to route the statements to the session manager 204. After receiving the statements, the session manager 204 is configured to retrieve all the data relating the user from the user database 208 and create a user session packet that stores the statements along with the user data retrieved. The session packet is configured to be updatable throughout the user session to incorporate any additional information submitted by the user during the course of the user session.

The set of logical objective statements in the session packet is examined by the session manager 204, in view of the other user information stored in the packet, to determine whether the statements contain sufficient information for the session manager 204 to identify the service or services requested by the user. The session manager 204 accomplishes this by parsing the information (i.e., logical objectives statements and user information) presented in the session packet and cross referencing them with a services database 212, that includes a listing of all the services registered to the voice interface system, to determine if the statements can be matched to one of the registered services. A service data management interface 214 is linked to the services database 212 and is configured to allow a service provider, a system administrator, or other authorized entity to make additions and modifications to the information in the services database 212.

Still with FIG. 2, if the session packet lacks sufficient information for the session manager 204 to identify the requested service, the session manager 204 can be configured to generate a text file that queries the user to present the missing information and send that text file to the target prospector 202. In one embodiment, the text file is formatted such that the query already includes the proper linguistic context to be understood by the user. In another embodiment, the target prospector is configured to apply a logical algorithm (e.g., NLP, OSP, etc.) to the text file to provide the proper linguistic context to the query so that the query can be readily understood by the user.

When the target prospector 202 determines that the query is in the proper linguistic context, the text file is sent by the target prospector 202 to a voice generator module 108 that is configured to convert the text file into an audio clip, play the audio clip, and synthesize the appropriate sounds to be communicated to the mobile telephony device operated by the user. In one embodiment, this communications dialogue between the user and target prospector 202 is repeated until the session manager 204 determines that the set of logical objective statements contain enough information for the session manager 204 to identify which service is being requested by the user. In another embodiment, this dialogue is repeated a pre-determined number of times as specified by the system administrator.

Once the session manager 204 has obtained enough information from the user to determine the service(s) requested, the session manager 204 then ascertains whether the requested services require the user to be authenticated and, if so, what those authentication requirements are. For services requiring authentication, an authentication module 106 is configured to work in conjunction with the session manager 204 to authenticate the user to access those services. Initially, the session manager 204 parses the session packet to determine if the required authentication data has already included in the packet. When authentication information is already included in the packet, the session manager 204 communicates the authentication information to the authentication module 106 for approval. When the authentication information is not found in the session packet or when the authentication information submitted to the authentication module 106 is not approved, the session manager 204 is configured to generate a text file that queries the user to provide the missing authentication information and send that text file to the target prospector 202. In one embodiment, the text file is already formatted such that the query already includes the proper linguistic context to be understood by the user. In another embodiment, the target prospector is configured to apply a logical algorithm (e.g., NLP, OSP, etc.) to the text file to provide the proper linguistic context to the query so that the query can be readily understood by the user.

Remaining with FIG. 2, after the target prospector 202 determines that the query is in the proper linguistic context, the text file is sent by the target prospector 202 to a voice generator module 108 that is configured to convert the text file into an audio clip, play the audio clip, and synthesize the appropriate sounds to be communicated to the telephony device operated by the user. In one embodiment, this querying process is repeated until the session manager 204 obtains enough authentication information to successfully authenticate the user with the authentication module 106. In another embodiment, this querying process is repeated only a pre-determined number of times as specified by the system administrator.

Once the session manager 204 receives enough information to determine the services requested by the user and has successfully authenticated the user to access those requested services, the session manager selects and activates the domain system agents (from a pool of domain system agents 206) associated with each of the requested services. After activation, the domain system agents are configured to arbitrate all subsequent data communications between the user and the domain systems 216 hosting the requested service. Some examples of arbitration activities that are performed by the domain system agents include, collecting additional user information necessary for the requested service to be performed, providing regionalized delivery of the services provided to the user based on user information found in the session packet, etc. The examples of arbitration activities described above are used for illustrative purposes only and are not meant to limit the types of arbitration activities that the domain system agents are capable of performing. Each domain system agent is configured to be customizable to perform essentially any type of arbitration activity as long as the activity involves some form of communication of data between the target prospector 202 and the domain system 216 hosting the service associated with the domain agent.

Examples of programming languages that can be used to create the domain system agents include JAVA™, Practical Extraction and Report Language (PERL), JAVASCRIPT™, Extensible Markup Language (XML), PYTHON™, and RUBY™. It should be understood, however, that essentially any programming language can be used to create the domain system agents as long as the language can effectuate the required functions of the domain system agents.

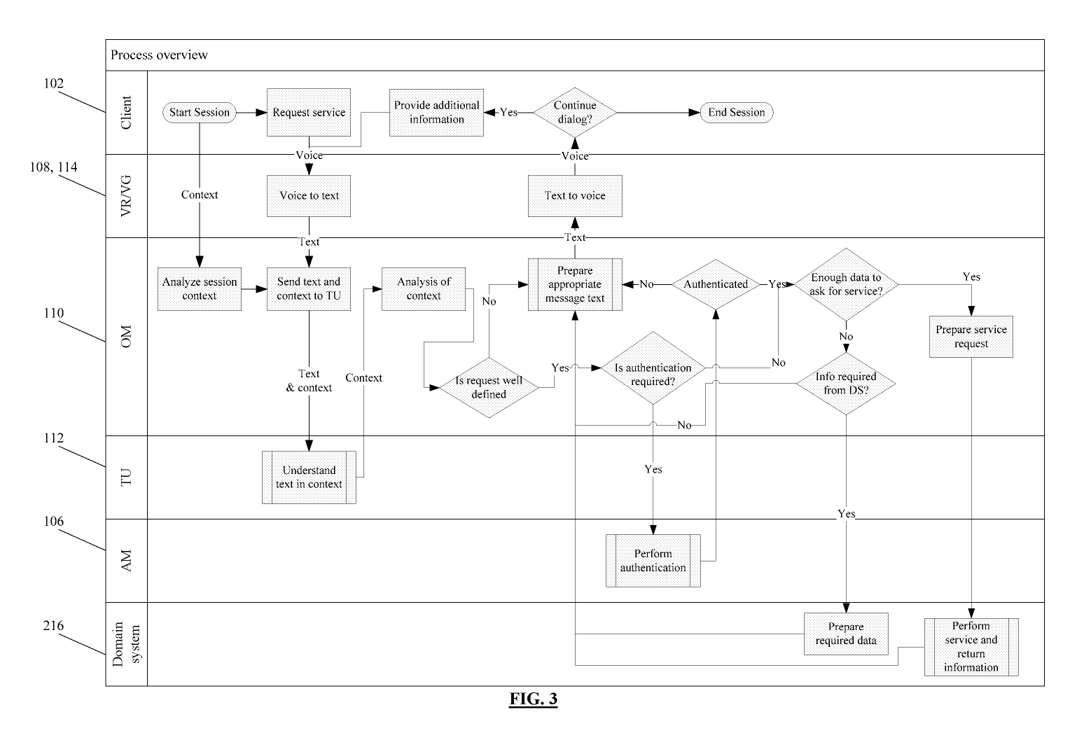

FIG. 3 is an illustration of a process flowchart detailing the processing steps executed by the voice interface system when a user accesses a networked resource via voice commands, in accordance with one embodiment. As depicted in this flowchart, the user 102 requests a service using voice data that the user presents to the voice recognition module 108 by way of a telephony device. The voice recognition module 108 can be configured to convert the voice data into a text file and forward that text file to the order manager 110. The order manager 110 sends the text to a text understanding module 112 that can be configured to covert the text into a set of logical objective statements and send the statements back to the order manager 110 for analysis. The order manager can create a session packet (i.e., “context”) that envelops the set of logical objective statements along with other user information that the order manager 110 extracts from a user database linked to the order manager 110.

When the order manager 110 determines that the information is not sufficient to determine which services the user is requesting, the order manager 110 can be configured to generate an appropriate text file query asking the user to provide additional information about the request. The text file can be sent to the voice generator module 114, which can be configured to convert the text file into an audio clip, play that audio clip, and synthesize the appropriate audio sounds to communicate the contents of the clip to the telephony device operated by the user 102. In one embodiment, the process is repeated until sufficient information is communicated by the user for the order manager 110 to determine the identity of the services that the user is requesting. In another embodiment, the process is repeated a pre-determined number of times before the order manager 110 ceases communications with the user.

Still with FIG. 3, when the order manager 110 determines that the information in the session packet is sufficient to determine which services are being requested by the user, the order manager 110 can proceed to determine whether user authentication is required to access those services. When the services require user authentication, the order manager 110 can be configured to send user authentication information present in the session packet to the authentication module 106 for authentication approval. Should the user authentication information fail to be approved by the authentication module 106, the order manager 110 can be configured to generate an appropriate text file query asking the user to submit the appropriate authentication information. As discusses above, the text file can be converted by the voice generator module 114 and communicated to the telephony device the user is operating. In one embodiment, this process is repeated (i.e., looped) until the order manager 110 receives authentication information from the user that is approved by the authentication module 106. In another embodiment, this process is repeated a pre-determined number of times before the order manager 110 generates a denial of access message to the user. In still another embodiment, the order manager 110 can be configured to end the process when the authentication module 106 detects authentication code evading activities on the part of the user.

Once the order manager 110 determines either that the services requested by the user do not require authentication or that the user has been approved by the authentication module 106, the order manager 110 can be configured to activate each domain system agent associated with each requested service the user is approved to access. For example, if the user is approved to access “bank account balances”, “balance transfer”, and “electronic payment” services on a bank domain system, the respective domain system agents for each service are activated.

The domain system agents can be configured to analyze the user session packet to determine if there is sufficient information for the requested services to be performed by the domain system 216. When the domain system agent determines that the session packets contain sufficient information to perform the requested service, the agent can prepare the service request for submission to the appropriate domain system 216 hosting the requested service for execution. When the domain system agent determines that the session packets do not contain sufficient information to perform the requested service, the agent can prompt the order manager 110 to generate a text file to query the user to present the required information for the domain system to provide the requested service. In one embodiment, this process is repeated (i.e., looped) until the domain system agent receives the necessary information from the user to execute the requested service. In another embodiment, this process is repeated a pre-determined number of times before the domain system agent drops the user request and deactivates.

The embodiments, described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The systems and methods described herein can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments have been described in detail herein, it should be understood, by those of ordinary skill, that the systems and methods described herein may be embodied in many other specific forms without departing from the spirit or scope of the invention. Therefore, the present examples and embodiments are to be considered as illustrative and not restrictive, and the systems and methods described herein are not to be limited to the details provided therein, but may be modified and practiced within the scope of the appended claims.

1. A system for using voice communications to access a plurality of networked services, comprising:
a voice recognition module in communications with a network, the voice recognition module configured to receive a voice command from a telephony device connected to the network and transform the voice command into a text file;
a text understanding module configured to translate a text file into a set of structured logical objectives;
a first domain system configured to host the plurality of networked services;
a pool of domain system agents associated with each of the plurality of networked services; and
an order manager in communications with the voice recognition module, the text understanding module, and the pool of domain system agents, wherein,
the order manager is configured to,
receive the set of structured logical objectives from the text understanding module,
determine whether the set of structured logical objectives contains necessary information to identify which networked service is being requested by the telephony device, and
when the set of structured logical objectives contains the necessary information, activate the domain system agent associated with the requested networked service, the domain system agent being configured to facilitate communications between the telephony device and the first domain system.

2. The system for using voice communications to access networked services, as recited in claim 1, further including an authentication module in communications with the order manager, the authentication module configured to determine a required authentication level to access the requested network service.

3. The system for using voice communications to access networked services, as recited in claim 2, wherein the authentication module authenticates a user to the required authentication level using biometrics authentication information from the user.

4. The system for using voice communications to access networked services, as recited in claim 2, wherein the authentication module authenticates a user to the required authentication level using a unique identification code provided by the user through the telephony device.

5. The system for using voice communications to access networked services, as recited in claim 2, wherein the order manager is further configured to generate a question text file requesting for additional authentication data to be submitted by a user of the telephony device when the user fails to successfully authenticate to the required authentication level and send that question text file to a voice generator module.

6. The system for using voice communications to access networked services, as recited in claim 1, wherein the network is a telephony network.

7. The system for using voice communications to access networked services, as recited in claim 1, wherein the network is a wide area network (WAN).

8. The system for using voice communications to access networked services, as recited in claim 1, wherein the telephony device is a mobile phone.

9. The system for using voice communications to access networked services, as recited in claim 1, wherein the telephony device is an Internet communications device.

10. The system for using voice communications to access networked services, as recited in claim 1, wherein the text understanding module translates the text file using a natural language processing (NLP) resource.

11. The system for using voice communications to access networked services, as recited in claim 1, wherein the text understanding module translates the text file using an ontological semantics (OS) resource.

12. The system for using voice communications to access networked services, as recited in claim 1, wherein the domain system agent is further configured to provide the networked service requested by a user of the telephony device.

13. The system for using voice communications to access networked services, as recited in claim 5, wherein the order manager is further configured to generate a question text file requesting for additional data to be submitted by a user of the telephony device when the set of structured logical objectives does not contain the necessary information to determine which networked service is requested and send that question text file to a voice generator module.

14. The system for using voice communications to access networked services, as recited in claim 13, wherein the domain system agent is further configured to generate question text file requesting for additional data to be submitted by a user of the telephony device when the set of structured logical objectives does not contain information required for the requested network service to be provided.

15. The system for using voice communications to access networked services, as recited in claim 14, wherein the voice generator module is configured to translate the question text file into an audio clip and send the audio clip to the telephony device.

16. A method for accessing networked services using voice communications, comprising:
receiving a voice command;
converting the voice command into a text file;
translating the text file into a set of structured logical objectives using a text understanding module and a language processing resource;
analyzing the set of structured logical objectives to determine whether the set of structured logical objectives contains necessary information to identify which networked service is being requested by the voice command; and
when the set of structured logical objectives contains the necessary information, activating a domain system agent associated with the requested networked service.

17. The method for accessing networked services using voice communications, as recited in claim 16, further including:
determining a required authentication level for an originator of the voice command to access the requested networked service;
examining authentication data associated with the originator to determine whether the authentication data satisfies the required authentication level;
generating a question text file requesting for additional authentication data to be submitted by the originator when the authentication data fails to satisfy the required authentication level for the networked service;
sending the question text file to a voice generator module;
converting the question text file into an audio clip; and
sending the audio clip to the originator.

18. The method for accessing networked services using voice communications, as recited in claim 17, wherein the authentication data is biometric identification information obtained from the originator.

19. The method for accessing networked services using voice communications, as recited in claim 17, wherein the authentication data is a unique identification code provided by the originator through a telephony device

20. The method for accessing networked services using voice communications, as recited in claim 16, wherein language processing resource is a natural language processor resource.

21. The method for accessing networked services using voice communications, as recited in claim 16, wherein the language processing resource is an ontological semantics resource.

22. The method for accessing networked services using voice communications, as recited in claim 16, wherein the voice command originates from a user communicating with a telephony device.

23. The method for accessing networked services using voice communications, as recited in claim 16, wherein the domain system agent is in communications with an originator of the voice command and a domain system hosting the networked service.

24. The method for accessing networked services using voice communications, as recited in claim 23, wherein the domain system agent is configured to facilitate communications between the originator and the domain system.

25. The method for accessing networked services using voice communications, as recited in claim 16, further including:
generating a question text file requesting for additional data to be communicated by an originator of the voice command when the set of structured logical objectives does not contain the necessary information to identify which networked service is being requested;
sending the question text file to a voice generator module;
converting the question text file into an audio clip; and
sending the audio clip to the originator.

26. The method for accessing networked services using voice communications, as recited in claim 16, further including
generating a question text file requesting for additional data to be communicated by an originator of the voice command when the set of structured logical objectives does not contain information required for the requested network service to be provided;
sending the question text file to a voice generator module;
converting the question text file into an audio clip; and
sending the audio clip to the originator.

27. A method for interactively acquiring data for accessing networked services, comprising:
receiving a request to access networked services;
creating a session packet that includes applicable data from the request;
evaluating the applicable data in the session packet to determine whether the request includes required data,
when the request lacks the required data, generating a question to query the required data; and
sending the question to a voice generator object.

28. The method for interactively acquiring data for accessing networked services, as recited in claim 27, further including:
generating an audio clip to effectuate the question; and
sending the audio clip to an originator of the request.

29. The method for interactively acquiring data for accessing networked services, as recited in claim 27, further including:
receiving the required data; and
updating the session agent with the required data.

30. The method for interactively acquiring data for accessing networked services, as recited in claim 27, wherein the required data is information required for determining which networked service is being requested.

31. The method for interactively acquiring data for accessing networked services, as recited in claim 27, wherein the required data is information required for authenticating the originator of the request.

32. The method for interactively acquiring data for accessing networked services, as recited in claim 27, wherein the required data is information required for the requested network service to be provided.
